(19) United States
(12) Patent Application Publication
(10) Pub. No.: US 2025/0360687 A1
(43) Pub. Date: Nov. 27, 2025

(54) SAG-RESISTANT BUILDING PANEL

(71) Applicant: ARMSTRONG WORLD INDUSTRIES, INC., Lancaster, PA (US)

(72) Inventors: Peter J. OLESKE, Lancaster, PA (US); Edward E. WISE, Lancaster, PA (US); Christian BUSQUE, Lititz, PA (US)

(73) Assignee: ARMSTRONG WORLD INDUSTRIES, INC., Lancaster, PA (US)

(21) Appl. No.: 19/294,797

(22) Filed: Aug. 8, 2025

Related U.S. Application Data
(63) Continuation of application No. 17/849,024, filed on Jun. 24, 2022.
(60) Provisional application No. 63/218,593, filed on Jul. 6, 2021.

(51) Int. Cl. B32B 5/26; B32B 5/02; B32B 7/02; B32B 7/12; E04B 9/04; E04C 2/26

(52) U.S. Cl. CPC B32B 5/265; B32B 5/022; B32B 7/02; B32B 7/12; E04B 9/04; E04C 2/26; B32B 2250/20; B32B 2262/02; B32B 2262/101; B32B 2262/108; B32B 2264/02; B32B 2264/1021; B32B 2264/1022; B32B 2264/1027; B32B 2264/104; B32B 2307/718; B32B 2307/724; B32B 2307/732; B32B 2419/00

(57) ABSTRACT

Described herein is a building panel comprising a body comprising a first fibrous material comprising inorganic fiber, a non-woven scrim coupled to the body; and wherein the non-woven scrim has a thickness ranging from about 8 mils to about 20 mils.

### CROSS-REFERENCE TO RELATED APPLICATIONS

This application is a Continuation of U.S. patent application Ser. No. 17/849,024, filed on Jun. 24, 2022, which claims the benefit of U.S. Provisional Application No. 63/218,593, filed on Jul. 6, 2021. The disclosure of the above application is incorporated herein by reference.

### BACKGROUND

Building panels have a tendency to deform in shape when exposed to moisture-whether by water in the form of droplets that originate from condensation or a leak on pipes and ductwork that are located in a mechanical space of a building. Previous attempts at preventing such deformation required costly materials or prevented the use of cheaper materials as such deformation would worsen. Therefore a need exists for a more cost-effective panel that exhibit superior dimensional stability when exposed to moisture.

### BRIEF SUMMARY

Some embodiments of the present invention include a building panel comprising: a body comprising a first fibrous material comprising inorganic fiber; a non-woven scrim coupled to the body; and wherein the non-woven scrim has a thickness ranging from about 8 mils to about 20 mils.

Other embodiments of the present invention include a building panel comprising: a body comprising a fibrous material that is present in an amounting ranging from about 15 wt. % to about 35 wt. % based on the total weight of the body; a facing layer having a basis weight ranging from about 2.0 g/ft² to about 5.0 g/ft²; and wherein the facing layer is coupled to the body, and the facing layer comprises a non-woven scrim.

Other embodiments of the present invention include a building panel comprising: a body having a first major surface opposite a second major surface and a side surface extending between the first and second major surface, the body having a first thickness as measured between the first major surface and the second major surface of the body, and the body comprising a fibrous material; a facing layer having a basis weight ranging from about 2.4 g/ft² to about 4.0 g/ft², the facing layer having a first major surface opposite a second major surface and a side surface extending between the first and second major surface, the facing layer having a second thickness as measured between the first major surface and the second major surface of the facing layer, and the facing layer comprising a non-woven scrim; and wherein the facing layer is coupled to the body, and wherein a ratio of the first thickness to the second thickness ranges from about 20:1 to about 125:1.

Other embodiments of the present invention include a ceiling system comprising a plurality of support elements; and at least one of the aforementioned building panels supported by one or more the plurality of support elements.

Other embodiments of the present invention include a method of forming a building panel comprising: a) bringing together a body and a facing layer to form an interface there-between, whereby an adhesive is present in the interface; wherein the body has a first thickness, the facing layer has a second thickness, and a ratio of the first thickness to the second thickness ranges from about 20:1 to about 125:1; and wherein the facing layer has a basis weight ranging from about 2.4 g/ft² to about 4.0 g/ft².

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is top perspective view of a building panel according to the present invention;

FIG. 2 is a cross-sectional view of the building panel according to the present invention, the cross-sectional view being along the VI line set forth in FIG. 1; and

FIG. 3 is a ceiling system comprising the building panel of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such.

Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

Unless otherwise specified, all percentages and amounts expressed herein and elsewhere in the specification should be understood to refer to percentages by weight. The amounts given are based on the active weight of the material. According to the present application, the term “about” means +/−5% of the reference value. According to the present application, the term “substantially free” less than about 0.1 wt. % based on the total of the referenced value.

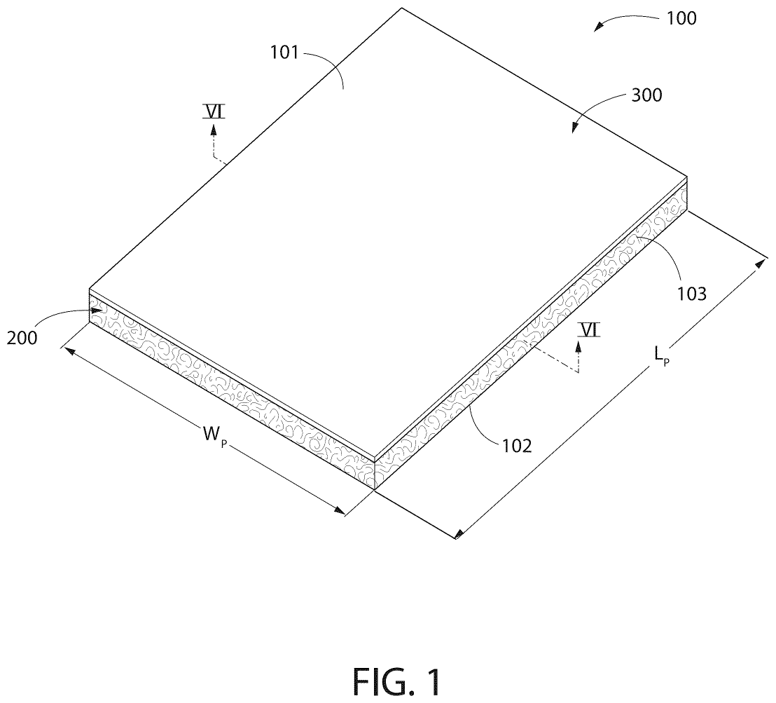

Referring to FIG. 1, the present invention includes a building panel 100 comprising a first major exposed surface 101 opposite a second major exposed surface 102 and a side exposed surface 103 that extends between the first major exposed surface 101 and the second major exposed surface 102.

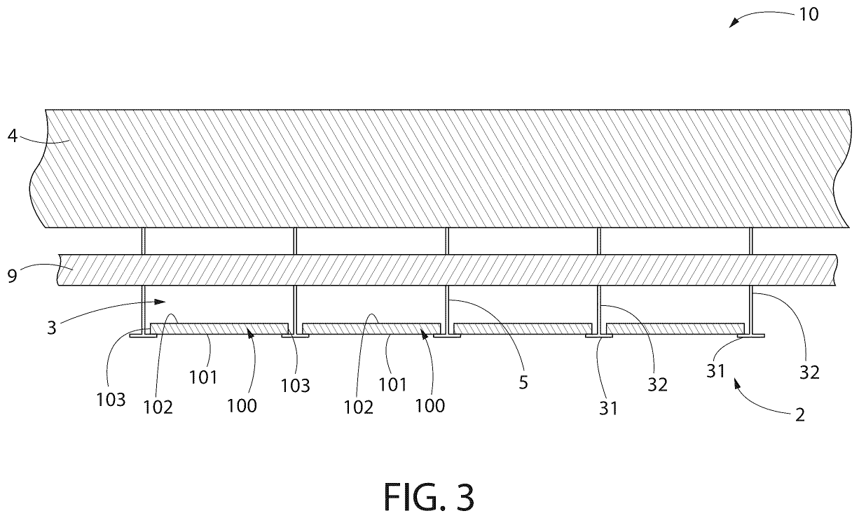

Referring to FIG. 3, the present invention may further include a ceiling system 1 comprising one or more of the building panels 100 installed in an interior space, whereby the interior space comprises a plenum space 3 and an active room environment 2. In such embodiments, the building panel 100 may be referenced as a ceiling panel 100. The plenum space 3 provides space for mechanical lines 9 within a building (e.g., HVAC, plumbing, etc.). The active space 2 provides room for the building occupants during normal intended use of the building (e.g., in an office building, the active space would be occupied by offices containing computers, lamps, etc.).

In the installed state, the building panels 100 may be supported in the interior space by one or more parallel support struts 5. Each of the support struts 5 may comprise an inverted T-bar having a horizontal flange 31 and a vertical web 32. The ceiling system 1 may further comprise a plurality of first struts that are substantially parallel to each other and a plurality of second struts that are substantially perpendicular to the first struts (not pictured). In some embodiments, the plurality of second struts intersects the plurality of first struts to create an intersecting ceiling support grid. The plenum space 3 exists above the ceiling support grid 6 and the active room environment 2 exists below the ceiling support grid 6.

In the installed state, the first major exposed surface 101 of the building panel 100 may face the active room environment 2 and the second major exposed surface 102 of the building panel 100 may face the plenum space 3.

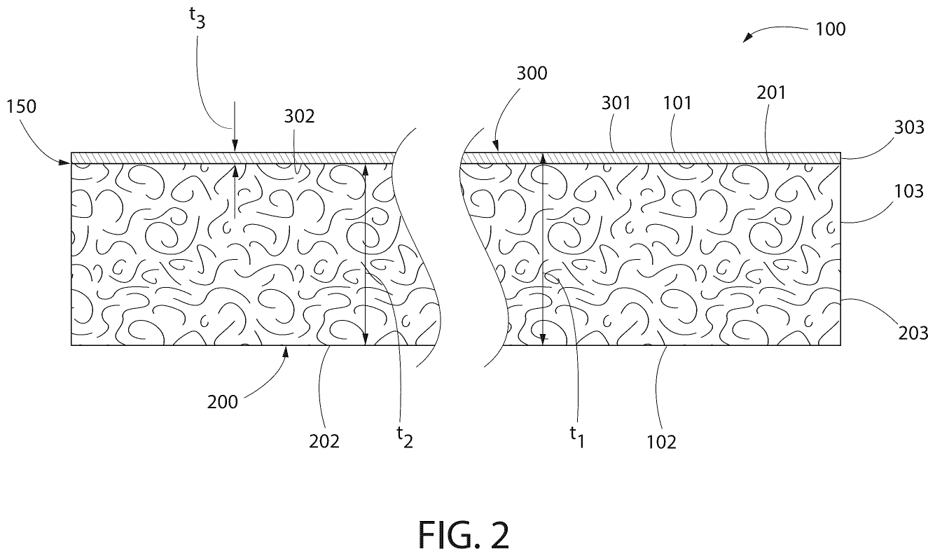

Referring now to FIGS. 1 and 2, the building panel 100 of the present invention may have a panel thickness t₁ as measured from the first major exposed surface 101 to the second major exposed surface 102. The panel thickness t₁ may range from about 0.4 inch to about 1.0 inch—including all values and sub-ranges there-between. In some embodiments, the panel thickness t₁ may range from about 0.5 inch to about 0.75 inch—including all values and sub-ranges there-between.

The building panel 100 may have a length L_{P} ranging from about 12 inch to about 72 inch—including all values and sub-ranges there-between. In some embodiments, the building panel 100 may have a length L_{P} ranging from about 24 inch to about 60 inch—including all values and sub-ranges there-between.

The building panel 100 may have a width W_{P} ranging from about 12 inch to about 30 inch—including all values and sub-ranges there-between. The building panel 100 may have a width W_{P} ranging from about 20 inch to about 24 inch—including all values and sub-ranges there-between.

The building panel 100 may comprise a body 200 and a facing layer 300 applied thereto. As discussed in greater detail herein, the facing layer 300 may be bonded to the body 200.

The body 200 comprises a first major surface 201 (also referred to as an “upper surface”) opposite a second major surface 202 (also referred to as a “lower surface”) and a side surface 203 that extends between the first major surface 201 and the second major surface 202 of the body 200.

The body 200 may have a body thickness t₂ that as measured by the distance between the first major surface 201 and the second major surface 202 of the body 200. The body thickness t₂ may range from about 0.4 inch to about 1.0 inch—including all values and sub-ranges there-between. In some embodiments, the body thickness t₂ may range from about 0.5 inch to about 0.75 inch—including all values and sub-ranges there-between. In a non-limiting example, the body thickness t₂ may be about 0.63 inch.

The body 200 may comprise a first fibrous material. The body 200 may comprise a first binder. In some embodiments, the body 200 may further comprise a filler and/or additive.

Non-limiting examples of the first fibrous material may include organic fibers, inorganic fibers, or a blend thereof. Non-limiting examples of inorganic fibers mineral wool (also referred to as slag wool), rock wool, stone wool, and glass fibers (also referred to as “fiber-glass”). Non-limiting examples of organic fiber include fiberglass, cellulosic fibers (e.g. paper fiber—such as newspaper, hemp fiber, jute fiber, flax fiber, wood fiber, or other natural fibers), polymer fibers (including polyester, polyethylene, aramid—i.e., aromatic polyamide, and/or polypropylene), protein fibers (e.g., sheep wool), and combinations thereof.

The first fibrous material may be inorganic fiber, whereby the first fibrous material in an amount ranging from 0 wt. % to about 50 wt. %, based on the total weight of the body 200—including all percentages and sub-ranges there-between. In some embodiments, the body 200 may comprise the first fibrous material in an amount ranging from about 1 wt. % to about 50 wt. %, based on the total weight of the body 200—including all percentages and sub-ranges there-between. In some embodiments, the body 200 may comprise the first fibrous material in an amount ranging from about 10 wt. % to about 40 wt. %, based on the total weight of the body 200—including all percentages and sub-ranges there-between. In some embodiments, the body 200 may comprise the first fibrous material in an amount ranging from about 15 wt. % to about 30 wt. %, based on the total weight of the body 200—including all percentages and sub-ranges there-between. In some embodiments, the body 200 may comprise the first fibrous material in an amount ranging from about 22 wt. % to about 28 wt. %, based on the total weight of the body 200—including all percentages and sub-ranges there-between.

In some embodiments, the body 200 may comprise a second fibrous material that is a an organic fiber—such as cellulosic fiber—whereby the second fiber is present in an amount ranging from about 15 wt. % to about 35 wt. % based on the total weight of the body 200—including all percentages and sub-ranges there-between.

Non-limiting examples of first binder may include a starch-based polymer, polyvinyl alcohol (PVOH), a latex, polysaccharide polymers, cellulosic polymers, protein solution polymers, an acrylic polymer, polymaleic anhydride, epoxy resins, or a combination of two or more thereof.

The body 200 may comprise the first binder in an amount ranging from about 2.0 wt. % to about 10.0 wt. %, based on the total weight of the body 200—including all percentages and sub-ranges there-between. The body 200 may comprise the first binder in an amount ranging from about 3.0 wt. % to about 5.0 wt. %, based on the total weight of the body 200—including all percentages and sub-ranges there-between.

Non-limiting examples of filler may include powders of calcium carbonate, limestone, titanium dioxide, sand, barium sulfate, clay, mica, dolomite, silica, talc, perlite, polymers, gypsum, wollastonite, expanded-perlite, calcite, aluminum trihydrate, pigments, zinc oxide, or zinc sulfate.

The body 200 may comprise the filler in an amount ranging from about 10 wt. % to about 50 wt. %, based on the total weight of the body 200—including all percentages and sub-ranges there-between. In some embodiments, the body 200 may comprise the filler in an amount ranging from about 40 wt. % to about 50 wt. %, based on the total weight of the body 200—including all percentages and sub-ranges there-between.

According to the embodiments where the body 200 comprises the first fibrous material in an amount ranging from about 15 wt. % to about 35 wt. %—including all percentages and sub-ranges there-between, additional amounts of filler—such as perlite—may be included in the body 200 in an amount ranging from about 30 wt. % to 50 wt. %-based on the total weight of the body 200—including all percentages and sub-ranges there-between.

The porosity of the body 200 may allow for airflow through the body 200 under atmospheric conditions such that the building panel 100 may function as an acoustic building panel—specifically, an acoustic ceiling panel 100, which requires properties related to noise reduction and sound attenuation properties—as discussed further herein.

The body 200 may be porous, thereby allowing airflow through the body 200 between the first major surface 201 and the second major surface 202 of the body 200. The body 200 may have a porosity ranging from about 60% to about 98%—including all values and sub-ranges there between. In a preferred embodiment, the body 100 has a porosity ranging from about 75% to 95%—including all values and sub-ranges there between. According to the present invention, porosity refers to the following:

$$\% Porosity = [ {V}_{Total} - ( {V}_{B i n d e r} + {V}_{F} + {V}_{Filler} ) ] / {V}_{Total}$$

Where V_{Total} refers to the total volume of the body 200 defined by the first major surface 201, the second major surface 202, and the side surfaces 203 of the body 200—thereby including the volume occupied by each of the components that make up the body 200 as well as volume occupied by voids between various components. V_{Binder} refers to the total volume occupied by the binder in the body 200. V_{F} refers to the total volume occupied by the fibers in the body 200. V_{Filler} refers to the total volume occupied by the filler in the body 200. Thus, the % porosity represents the amount of free volume within the body 200.

The body 200 may have a first bulk density. The first bulk density may be measured by the total weight of the body 200 (including the weight of each component present—i.e., fibrous material, binder, filler, additives) divided by V_{Total} of the body 200. The first bulk density of the body 200 may range from about 8.5 lb./ft³ to about 13.5 lb./ft³—including all bulk densities and sub-ranges there-between

The building panel 100 of the present invention comprising the body 200 may exhibit sufficient airflow for the building panel 100 to have the ability to reduce the amount of reflected sound in a room. The reduction in amount of reflected sound in a room is expressed by a Noise Reduction Coefficient (NRC) rating as described in American Society for Testing and Materials (ASTM) test method C423. This rating is the average of sound absorption coefficients at four ⅓ octave bands (250, 500, 1000, and 2000 Hz), where, for example, a system having an NRC of 0.90 has about 90% of the absorbing ability of an ideal absorber. A higher NRC value indicates that the material provides better sound absorption and reduced sound reflection.

The building panel 100 of the present invention exhibits an NRC of at least about 0.5. In a preferred embodiment, the building panel 100 of the present invention may have an NRC ranging from about 0.60 to about 0.99—including all value and sub-ranges there-between.

The facing layer 300 may comprise a first major surface 301 (also referred to as an “upper surface”) opposite a second major surface 302 (also referred to as a “lower surface”) and a side surface 303 that extends between the first major surface 301 and the second major surface 302 of the facing layer 300.

The facing layer 300 may have a facing layer thickness t₃ that as measured by the distance between the first major surface 301 and the second major surface 302 of the facing layer 300. The facing layer thickness t₃ may range from about 8.0 mils to about 20 mils—including all values and sub-ranges there-between. In some embodiments, the facing layer thickness t₃ may range from about 12.0 mils to about 16.0 mils—including all values and sub-ranges there-between. In a non-limiting example, the facing layer thickness t₃ may be about 14 mils.

A ratio of the body thickness t₂ to the facing layer thickness t₃ may range from about 20:1 to about 125:1—including all ratios and sub-ranges there-between. In some embodiments, the body thickness t₂ to the facing layer thickness t₃ may range from about 31:1 to about 81:1—including all ratios and sub-ranges there-between.

A ratio of the panel thickness t₁ to the facing layer thickness t₃ may range from about 20:1to about 125:1—including all ratios and sub-ranges there-between. A ratio of the panel thickness t₁ to the body thickness t₂ may range from about 31:1 to about 81:1—including all ratios and sub-ranges there-between.

The ratio of the panel thickness t₁ to the facing layer thickness t₃ may be substantially equal to the ratio of the body thickness t₂ to the facing layer thickness t₃ due to the facing layer thickness t₃ being at least two orders of magnitude smaller than the body thickness t₂.

The facing layer 300 may be positioned atop the upper surface 201 of the body 200. An interface 150 may be formed between the facing layer 300 and the body 200. The second major surface 302 of the facing layer 300 may face the first major surface 201 of the body 200. The interface 150 may be formed between the second major surface 302 of the facing layer 300 and the first major surface 201 of the body 200.

The facing layer 300 may comprise a non-woven scrim. In some embodiments, the facing layer 300 may be a non-woven scrim. In such embodiments, the facing layer 300 may consist essentially of a non-woven scrim. The facing layer 300 comprising the non-woven scrim may be substantially free of impregnated films. The non-woven scrim may form about 100 wt. % of the facing layer 300.

The facing layer 300 may comprise a third fibrous material. The facing layer 300 may comprise a second binder. In some embodiments, the facing layer 300 may further comprise a filler and/or additive.

Non-limiting examples of the third fibrous material may be selected from one or more of the aforementioned inorganic fibrous materials.

The facing layer 300 may be porous, thereby allowing airflow through the facing layer 300 between the first major surface 301 and the second major surface 302 of the facing layer 300—as discussed further herein. The facing layer 300 may have an air permeability of about 1,000 (ft3/min/ft2)

The facing layer 300 may exhibit an airflow resistance as measured between the first major surface 301 and the second major surface 302 of the facing layer 300. The airflow resistance of the facing layer 300 may range from 0 mks rayls to about 100 mks rayls—including all values and sub-ranges there between. According to the present invention, it is possible for the facing layer 300 to have a zero airflow resistance for the purpose of such mks rayls measurements. In some embodiments, the airflow resistance of the facing layer 300 may less than about 50 mks rayls. In some embodiments, the airflow resistance of the facing layer 300 may less than about 10 mks rayls.

The specific airflow resistance of an acoustical structure is a permeability or porosity property that determines the sound-absorptive and sound-transmitting properties of the structure. Outer facing layers with greater porosity allow sound to pass through the layer to the core rather than being reflected back into the room thereby improving sound absorption and the NRC value of the acoustical substrate. Specific airflow resistance may be determined by ASTM standard C522 and is measured in units of mks rayls (Pa·s/m). This test method is designed for the measurement of values of specific airflow resistance with linear airflow velocities ranging from 0.5 to 50 mm/s and pressure differences across the specimen ranging from 0.1 to 250 Pa. Increasingly higher airflow resistance values represent correspondingly denser and less porous facings.

The facing layer 300 may have a second bulk density-the second bulk density being less than the first bulk density.

The facing layer 300 may have a basis weight ranging from about 2.0 to about 5.0—including all basis weights and sub-ranges there-between. In some embodiments, the basis weight of the facing layer 300 may range from about 2.4 g/ft² to about 4.0 g/ft²—including all basis weights and sub-ranges there-between. In some embodiments, the basis weight of the facing layer 300 may be about 3.2 g/ft².

In some embodiments, the facing layer 300 of the present invention may be positioned directly adjacent to the first major surface 201 of the body 200. In such embodiments, at least a portion of the second major surface 302 of the facing layer 300 may be in direct contact with at least a portion of the first major surface 201 of the body 200.

The facing layer 300 may be bonded to the body 200. Specifically, the second major surface 302 of the facing layer 300 may be bonded to the first major surface 201 of the body 200. The facing layer 300 and the body 200 may be adhesively bonded together. In such embodiments, adhesive may at least be partially present in the interface 150. The adhesive may be in direct contact with the second major surface 302 of the facing layer 300. The adhesive 150 may be in direct contact with the first major surface 201 of the body 200.

Non-limiting examples of adhesive may include polyvinyl acetate emulsion. An amount of adhesive in the dry-state may be present in the interface 150 may range from about 3.0 g/ft² to about 6.0 g/ft²—including all amounts and sub-ranges there-between. In some embodiments, the adhesive in the dry-state may be present in the interface 150 may range from about 3.5 g/ft² to about 5.0 g/ft²—including all amounts and sub-ranges there-between.

The first major exposed surface 101 of the building panel 100 may comprise the facing layer 300. The first major exposed surface 101 of the building panel 100 may comprise the first major surface 301 of the facing layer 300. Stated otherwise, the first major surface 301 of the facing layer 300 may at least partially form the first major exposed surface 101 of the building panel 100.

According to the embodiments when the facing layer 300 comprises the non-woven scrim, the first major exposed surface 101 of the building panel 100 may comprise the non-woven scrim of the facing layer 300. According to the embodiments when the facing layer 300 comprises the non-woven scrim, the first major exposed surface 101 of the building panel 100 may comprise the first major surface 301 of the facing layer 300, wherein the first major surface 301 of the facing layer 300 is formed by the non-woven scrim. Stated otherwise, according to such embodiments, the non-woven scrim may at least partially form the first major surface 301 of the facing layer 300, which may at least partially form the first major exposed surface 101 of the building panel 100.

The second major exposed surface 102 of the building panel 100 may comprise the body 200. The second major exposed surface 102 of the building panel 100 may comprise the second major surface 202 of the body 200. Stated otherwise, the second major surface 202 of the body 200 may at least partially form the second major exposed surface 102 of the building panel 100.

The side exposed surface 103 of the building panel 100 may comprise the body 200. The side exposed surface 103 of the building panel 100 may comprise the facing layer 300. The side exposed surface 103 of the building panel 100 may comprise the side surface 203 of the body 200. The side exposed surface 103 of the building panel 100 may comprise the side surface 303 of the facing layer 300. Stated otherwise, the side surface 203 of the body 200 may at least partially form the side exposed surface 103 of the building panel 100. The side surface 303 of the facing layer 300 may at least partially form the side exposed surface 103 of the building panel 100.

In some embodiments, the side exposed surface 103 of the building panel 100 may comprise both the facing layer 300 and the body 200. In such embodiments, the side exposed surface 103 of the building panel may comprise both the side surface 303 of the facing layer 300 and the side surface 203 of the body 200. Stated otherwise, the side surface 203 of the body 200 and the side surface 303 of the facing layer 300 may collectively form at least a portion of the side exposed surface 103 of the building panel 100.

As shown in FIG. 2, the side exposed surface 103 of the building panel 100 may comprise a single planar surface that is substantially orthogonal to the first major exposed surface 101 of the building panel. In such embodiments, the side surface 303 of the facing layer 300 and the side surface 203 of the body 200 may collectively form the single planar side exposed surface 103 of the building panel 100.

In other embodiments, the side exposed surface 103 of the building panel 100 may comprise a tegular edge comprising a stepped-profile. In such embodiments, the side surface 303 of the facing layer 300 and the side surface 203 of the body 200 may collectively form the tegular edge of the side exposed surface 103 of the building panel 100.

The panel thickness t₁ of the building panel 100 may be substantially equal to the summation of the body thickness t₂ and the facing layer thickness t₃.

In some embodiments, the building panel 100 may further comprise a coating. The coating may be formed from a coating composition comprising a pigment composition. The coating composition may further comprise a binder. The coating composition may further comprise one or more additives and/or fillers.

In some embodiments, the coating may be applied to the facing layer 300. In some embodiments, the coating may be applied to the body 200. In a non-limiting embodiment, the coating may be applied atop the first major surface 301 of the facing layer 300. In such embodiments, the first major exposed surface 101 of the building panel 100 may comprise the coating. In a non-limiting embodiment, the coating may be applied atop the side surface 203 of the body 200. In such embodiments, the side exposed surface 103 of the building panel 100 may comprise the coating.

The coating may be in a dry-state, whereby the coating may comprise the pigment composition, binder, and/or additive while having less than about 0.1 wt. % of a liquid carrier based on the total weight of the coating.

The pigment composition present in the coating may comprise titanium dioxide, a clay, and one or more alkaline metal carbonates. In some embodiments, the pigment composition of the present invention may comprise titanium dioxide, a clay, one or more alkaline metal carbonates, and an alkali metal silicate.

The binder present in the coating may comprise one or more polymers selected from polyvinyl alcohol (PVOH), latex, an acrylic polymer, polymaleic anhydride, or a combination of two or more thereof. Non-limiting examples of latex binder may include a homopolymer or copolymer formed from the following monomers: vinyl acetate (i.e., polyvinyl acetate), vinyl propinoate, vinyl butyrate, ethylene, vinyl chloride, vinylidene chloride, vinyl fluoride, vinylidene fluoride, ethyl acrylate, methyl acrylate, propyl acrylate, butyl acrylate, ethyl methacrylate, methyl methacrylate, butyl methacrylate, hydroxyethyl methacrylate, hydroxyethyl acrylate, styrene, butadiene, urethane, epoxy, melamine, and an ester. Preferably the binder is selected from the group consisting of aqueous lattices of polyvinyl acetate, polyvinyl acrylic, polyurethane, polyurethane acrylic, polystyrene acrylic, epoxy, polyethylene vinyl chloride, polyvinylidene chloride, and polyvinyl chloride.

The coating may comprise one or more additives. Non-limiting examples of additives include surfactants, thickeners, emulsifiers, wetting agents, defoamers, preservatives, anti-bacterial agents, and the like.

The coating may be applied to the body 200 and/or the facing layer 300 by spray, roll, or vacuum coating in a wet-state (whereby liquid carrier is added to the coating composition) followed by drying the wet-state coating such that all liquid carrier is driven off thereby the coating in the dry-state. The coating in the wet-state may be present in an amount ranging from about 15.0 g/ft² to 25.0 g/ft²—including all amounts and sub-ranges there-between. The coating may be applied in the wet-state at a solid's content of about 60 wt. %. Once dried, the coating in the dry-state may be present in an amount ranging from about 9.0 g/ft² to 15.0 g/ft²—including all amounts and sub-ranges there-between. The coating may be applied in the wet-state at a solid's content of about 60 wt. %.

The facing layer 300 with the coating applied thereto may exhibit an airflow resistance ranging from about 100 mks rayls to about 500 mks rayls—including all airflow resistances and sub-ranges there-between. In some embodiments, the facing layer 300 with a coating applied thereto may exhibit an airflow resistance ranging from about 250 mks rayls to about 350 mks rayls—including all airflow resistances and sub-ranges there-between.

The facing layer 300 with the coating applied thereto may have a basis weight ranging from about 10.0 g/ft² to about 25.0 g/ft²—including all basis weights and sub-ranges there-between. In some embodiments, the basis weight of the facing layer 300 with the coating applied thereto may range from about 15.0 g/ft² to about 20.0 g/ft²—including all basis weights and sub-ranges there-between.

According to the present invention the combination of the facing layer 300 and the body 200 results in an unexpected improvement in dimensional stability for the building panel 100. Specifically, it has been surprisingly discovered that the facing layer 300 of the present invention bonded to the first major surface 201 of the body 200 helps prevent distortion of the building panel 100 when exposed to moisture, whereby the distortion may occur in a direction extending through the first major exposed surface 101 and the second major exposed surface 102 (also referred to as “anti-cupping” characteristics) due to a synergistic counterbalancing forces between the facing layer 300 and the body 200 when the facing layer 300 and the body 200 are bonded together.

The building panel 100 of the present invention may be manufactured according to a method that includes bringing together the body 200 and the facing layer 300 to form the interface 150 there-between. Specifically, the first major surface 201 of the body 200 may be brought in contact with the second major surface 301 of the facing layer 300 to create the interface. The adhesive may be present in the interface 150 when the body 200 and the facing layer 300 are brought together.

Before the body 200 and the facing layer 300 are brought together, the adhesive may be applied to at least one of the facing layer 300 and/or the body 200. In some embodiments, the adhesive may be applied to the first major surface 201 of the body 200 before formation of the interface 150. In some embodiments, the adhesive may be applied to the second major surface 302 of the facing layer 300 before formation of the interface 150.

The adhesive may be applied to the first major surface 201 of the body 200 in the wet-state an amount ranging from about 6.0 g/ft² to about 12.0 g/ft²—including all amounts and sub-ranges there-between. In some embodiments, the adhesive may be applied to the first major surface 201 of the body 200 in the wet-state an amount ranging from about 7.0 g/ft² to about 10.0 g/ft²—including all amounts and sub-ranges there-between. The adhesive in the wet-state may have a solid's content of about 50 wt. %.

The adhesive may be applied to the second major surface 302 of the facing layer 300 in the wet-state an amount ranging from about 6.0 g/ft² to about 12.0 g/ft²—including all amounts and sub-ranges there-between. In some embodiments, the adhesive may be applied to the second major surface 302 of the facing layer 300 in the wet-state an amount ranging from about 7.0 g/ft² to about 10.0 g/ft²—including all amounts and sub-ranges there-between.

The amount of adhesive in the wet-state that is present in the interface 150 immediately after bringing the body 200 in contact with the facing layer 300 may range from about 6.0 g/ft² to about 12.0 g/ft²—including all amounts and sub-ranges there-between. In some embodiments, the amount of adhesive in the wet-state that is present in the interface 150 immediately after bringing the body 200 in contact with the facing layer 300 may range from about 7.0 g/ft² to about 10.0 g/ft²—including all amounts and sub-ranges there-between.

Once brought together, pressure may be applied to at least one of the facing layer 300 and/or the body 200 to ensure proper adhesive bonding within the interface 150. In some embodiments, pressure may be applied to the first major surface 301 of the facing layer 300 in a direction toward the second major surface 202 of the body 200. In some embodiments, pressure may be applied to the second major surface 202 of the body 200 in a direction toward the first major surface 301 of the facing layer body 300. The adhesive may be allowed a period of time to fully set, cure, or dry thereby adhesively bonding together the facing layer 300 and body 200 through the interface 150. The resulting adhesive in the dry-state may be present in an amount ranging from about 3.0 g/ft² to about 6.0 g/ft²—including all amounts and sub-ranges there-between. In some embodiments, the resulting adhesive in the dry-state may be present in an amount ranging from about 3.5 g/ft² to about 5.0 g/ft²—including all amounts and sub-ranges there-between.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

### EXAMPLES

A number of experiments were performed to test the impact of scrim basis weight on dimensional stability of the resulting building panel before and after being exposed to moisture. The experiment included adhesively bonding a number of non-woven scrims to a number of fibrous panels to form the overall building panel, and exposing each building panel to moisture in the form of cycles of 90% relative humidity at 90° F. and 35% relative humidity at 90° F., whereby the amount of cupping for each panel was recorded before and after exposure to moisture. Each panel was then assigned either a pass or fail grade depending on whether the amount of deflection exceeded an allowable threshold for cupping—i.e., the passing grades not exceeding the threshold and the failing grades exceeding such threshold. The formulation and test results are set forth below in Table 1.

In the below Table 1, a passing grade for cupping is a building panel that exhibits a dimensional stability to the extent that, after exposure to the humidity cycles, the resulting building panel does not give a visual indication of deformation. Therefore, while the building panel that achieves a passing grade for cupping may exhibit slight cupping, such cupping is not apparent to the naked eye and therefore still achieves a passing grade. A failing grade for cupping is a building panel that fails to exhibit a dimensional stability to the extent that, after exposure to the humidity cycles, the resulting building panel gives a visual indication of deformation to the naked eye.

In the below Table 1, a passing grade for price threshold is a building panel that may be formed from materials that allows a supplier to competitively sell such product without necessitating a cost-prohibitive pricing in such market. A failing grade for price threshold is a building panel that is formed of materials that prevent a supplier to competitively sell such product without necessitating a cost-prohibitive pricing in such market.

TABLE 1

| | Comp. | Comp. | Comp. | Comp. | Comp. | | |
|---|---|---|---|---|---|---|---|
| | Ex. 1 | Ex. 2 | Ex. 3 | Ex. 4 | Ex. 5 | Ex. 1 | Ex. 2 |
| Fibrous Panel | | | | | | | |
| Fiber Type | MW | MW | MW | MW | MW | MW | MW |
| Amount of Fiber (wt. %) | 50-60 | 50-60 | 50-60 | 60-70 | 10-20 | 10-20 | 20-30 |
| Amount of Filler | 30-40 | 30-40 | 30-40 | 30-40 | 50-60 | 50-60 | 50-60 |
| Thickness (inch) | 1.0 | 1.0 | 0.875 | 0.875 | 0.625 | 0.5 | 0.5 |
| Non-Woven Scrim | | | | | | | |
| Basis Weight (g/ft²) | 7.8 | 3.2 | 7.8 | 3.2 | 7.8 | 3.2 | 3.2 |
| Thickness (mils) | 28.0 | 14.0 | 28.0 | 14.0 | 28.0 | 14.0 | 14.0 |
| Building Panel Cupping | Pass | Fail | Pass | Fail | Fail | Pass | Pass |
| Price Threshold | Fail | Fail | Fail | Fail | Pass | Pass | Pass |

As demonstrated by Table 1, it has been discovered that bonding a low-basis weight facing layer to the fibrous body results in a building panel having dimensional stability that allows for such building panel to exhibit superior resistance to cupping after exposure to moisture. The dimensional stability of such building panel may be achieved without requiring large amounts of certain material—such as mineral wool—which may be at least partially replaced by more cost effective material—such as filler (e.g., perlite), thereby providing a dimensionally superior building panel that is more cost effective to manufacture.

What is claimed is:

1. A building panel comprising:
a body comprising:
a first fibrous material comprising inorganic fiber selected from mineral wool, rock wool, and stone wool, the first fibrous material is present in the body in amount ranging from about 25 wt. % to about 30 wt. % based on the total weight of the body;
a filler present in amount ranging from about 50 wt. % to about 65 wt. % based on the total weight of the body; and
a non-woven scrim coupled to the body_by an adhesive in a dry state that is present in an amount ranging from about 3.0 g/ft² to about 6.0 g/ft²;
wherein the non-woven scrim has a thickness ranging from about 14 mils to about 20 mils; and
wherein the body has a bulk density ranging from about 8.5 lb./ft³ to about 13.5 lb./ft³.

2. The building panel according to claim 1, wherein the body comprises a second fibrous material that includes an organic fiber.

3. The building panel according to claim 1, wherein the body has a porosity ranging from about 77% to about 87%.

4. The building panel according to claim 1, wherein the filler is selected from calcium carbonate, limestone, titanium dioxide, sand, barium sulfate, clay, mica, dolomite, silica, talc, perlite, polymers, gypsum, wollastonite, expanded-perlite, calcite, aluminum trihydrate.

5. The building panel according to claim 1, wherein the adhesive is polyvinyl acetate.

6. The building panel according to claim 1, wherein the non-woven scrim exhibits an airflow resistance less than about 350 mks rayls.

7. The building panel according to claim 1, wherein the body comprises a first major surface opposite a second major surface and a body thickness as measured between the first major surface and the second major surface, wherein the body thickness ranges from about 0.675 inches to about 0.8125 inches.

8. A building panel comprising:
a body comprising:
a fibrous material that is present in an amounting ranging from about 25 wt. % to about 30 wt. % based on the total weight of the body, the fibrous material comprising mineral wool;
a filler that is present in an amount ranging from about 50 wt. % to about 65 wt. % based on the total weight of the body;
a facing layer having a basis weight ranging from about 3.5 g/ft² to about 4.0 g/ft²;
wherein the facing layer is coupled to the body by an adhesive, and the facing layer comprises a non-woven scrim;
wherein the body has a bulk density ranging from about 8.5 lb./ft³ to about 13.5 lb./ft³; and
wherein the adhesive is present in a dry-state an amount ranging from about 3.0 g/ft² to about 6.0 g/ft².

9. The building panel according to claim 8, wherein adhesive comprises polyvinyl acetate.

10. The building panel according to claim 8, wherein the inorganic fiber is selected from the group consisting of mineral wool, rock wool, stone wool, and glass fibers.

11. The building panel according to claim 8, wherein the body has a porosity ranging from about 77% to about 87%.

12. The building panel according to claim 8, wherein the body has a porosity ranging from about 80% to about 84%.

13. A building panel comprising:
a body having a first major surface opposite a second major surface and a side surface extending between the first and second major surface, the body having a first thickness as measured between the first major surface and the second major surface of the body, the body comprising a fibrous material that includes inorganic fiber selected from mineral wool, rock wool, and stone wool, the body having a bulk density ranging from about 8.5 lb./ft³ to about 13.5 lb./ft³;
a facing layer having a basis weight ranging from about 3.5 g/ft² to about 4.0 g/ft², the facing layer having a first major surface opposite a second major surface and a side surface extending between the first and second major surface, the facing layer having a second thickness as measured between the first major surface and the second major surface of the facing layer, and the facing layer comprising a non-woven scrim; and
wherein the facing layer is coupled to the body by an adhesive, and wherein a ratio of the first thickness to the second thickness ranges from about 35:1 to about 60:1;
wherein the first thickness ranges from about 0.675 inches to about 0.8125 inches; and
wherein the adhesive is polyvinyl acetate.

14. The building panel according to claim 13, wherein the fibrous material is present in the body wherein the body has a porosity ranging from about 80% to about 84%.

15. The building panel according to claim 13, wherein the body further comprises a filler present in the body in amount ranging from about 50 wt. % to about 65 wt. % based on the total weight of the body; and
wherein the filler is selected from calcium carbonate, limestone, titanium dioxide, sand, barium sulfate, clay, mica, dolomite, silica, talc, perlite, polymers, gypsum, wollastonite, expanded-perlite, calcite, aluminum trihydrate.

16. The building panel according to claim 13, wherein the second thickness ranges from about 14 mils to about 20 mils.

17. The building panel according to claim 13, wherein the facing layer is substantially free of impregnated film.

18. The building panel according to claim 13, wherein the fibrous material is present in amount ranging from about 25 wt. % to about 30 wt. % based on the total weight of the body.

19. The building panel according to claim 13, wherein the adhesive is polyvinyl acetate.

20. The building panel according to claim 13, wherein the adhesive is present in a dry-state an amount ranging from about 3.0 g/ft² to about 6.0 g/ft².
